(19) United States
(12) Patent Application Publication
(10) Pub. No.: US 2005/0155149 A1
(43) Pub. Date: Jul. 21, 2005

(54) Device and bed for turning horizontally lying persons

(76) Inventor: Flemming Buus Pedersen, Nibe (DK)

Correspondence Address: James C Wray, Suite 300, 1493 Chain Bridge Road, McLean, VA, 22101, US

(21) Appl. No.: 10/514,820

(22) PCT Filed: May 5, 2003
(86) PCT No.: PCT/DK03/00290

(30) Foreign Application Priority Data
May 17, 2002 (DK) 2002 00764

(51) Int. Cl. A61G 7/10

(52) U.S. Cl. 5/81.1 R; 5/88.1

(57) ABSTRACT

Auxiliary device for turning horizontally lying persons and for mounting e.g. on a bed, the device including one or more largely vertically displacing devices that may be manipulated in vertical direction by means of a control panel, each device including a largely horizontally arranged roller which is rotatably secured at each end in a rotatable bushing, and the each rotatable bushing is fastened on first member, the first member being concentrically and displacing arranged in a second member, and means are provided by which impulses from the control panel can displace the first member relatively to the second member uniformly at both ends of the roller, which thereby may be moved vertically.

The present invention concerns an auxiliary device for turning horizontally lying persons and for mounting e.g. on a bed, and a bed with one or more auxiliary devices mounted on the bed.

In connection with caring for bedfast persons, including particularly elderly people, this may make heavy demands on the physical capability of the nursing staff. When washing persons, it is necessary to turn the lying person in the bed, as well as in connection with many other tasks is necessary to attend to the person from several sides. Typically, this implies that the nurse, or care person, has to get hold of the lying person and push/roll the person from one side to another. This implies many disadvantages, both for the bedfast person and for the nursing staff.

Bedfast persons needing care are often physically weak, either due to sickness or due to frailty caused by old age, or a combination of sickness and age. Therefore, it will be a physical load on these persons to be manipulated by the nursing staff which is compelled to get hold on and pull the person for turning him.

Concurrently with the increasing numbers of bedfast elderly people and savings in the nursing area, less nursing staff is to care for more elderly. A large part of these elderly people are bedfast for shorter or longer periods, which makes special demands on the nursing staff. In order to reduce the load on the nursing staff, including particularly back and shoulders, it is required that more nurses cooperate for turning the bedfast person.

Where the bedfast person is in his own home, there is rarely possibility of more nurses turning the lying person. This implies that a single or one of a couple often has to lie on the same side for a long time without being turned, which has detrimental influence on the person's physical condition and on the hygiene in connection with being bedfast.

Therefore, there is a need for a solution that may help the nursing staff so that the heavy physical task of turning a lying person is alleviated, possibly by using less staff, and that a bedfast person possibly may turn himself alone.

The present invention provides for this need with an auxiliary device as described above, which is peculiar in that the device includes one or more largely vertically displacing devices that may be manipulated in vertical direction by means of a control panel, each device including a largely horizontally arranged roller which is rotatably secured at each end in a rotatable bushing, and the each rotatable bushing is fastened on first member, the first member being concentrically and displacing arranged in a second member, and means are provided by which impulses from the control panel can displace the first member relatively to the second member uniformly at both ends of the roller, which thereby may be moved vertically.

This auxiliary device enables that a sheet fastened to the horizontal roller to be pulled when the roller is moved upwards, whereby a bedfast person located on the sheet will be actuated to roll and thereby be turned. Compared with being manipulated by one or more nursing persons, the sheet will apply a far more even load on lying person, influencing the person far less physically than the point loads which the hands of the nursing staff will exert on a lying person.

Furthermore, due to the electric/mechanical structure of the auxiliary device, it will be possible for a single nursing person to turn even very big lying persons without physical effort. The device thus also provides for the need for improved care with reduced staff.

The members are concentrically arranged so that a member is displacing arranged in the second member and serve to control the roller both in vertical and horizontal directions. In a preferred embodiment, the means for relative displacement of the two members include a telescoping cylinder powered by pneumatics, hydraulics, electric step motor or the like. Thereby, the physical effort made by the possible nursing staff is substantially reduced, as the action for turning the lying person is provided by the relative displacing of the two members, the displacing in turn being provided by means of the above mentioned means. The nursing staff is thus only to concentrate on the lying person being in a position so that the person's longitudinal axis is largely in parallel with the longitudinal axis of the roller in order thereby to achieve the most comfortable rolling movement Besides, the nursing staff is to operate the control panel so that the auxiliary device may be manipulated vertically.

In a further, preferred embodiment, the control panel includes one or more manipulating means supplying the user's input and by which the means for vertical movement of the roller may be controlled, and that a rechargeable battery with associated charging unit are arranged in the control panel.

By providing a plurality of manipulation means, it becomes easier for the user to control individual functions. If a device is arranged at both sides of a bed, one may control each side at a time. This is thus securing that the movement and rotation of the bedfast person may be controlled better and more safely.

In case of power failure it will be desirable to finish the task that the user has given the auxiliary device instructions to by means of the manipulation means. A rechargeable battery with associated charging apparatus has therefore been provided so that the system includes a kind of back-up power supply which is to have a capacity large enough to perform the functions which the auxiliary device may be expected to perform without inconvenience for the lying person. Typically, the battery is to have a capacity corresponding to performing a complete turning around of the lying person.

In a further, preferred embodiment, the manipulation means are provided in a special separate unit that may communicate with input means in the control panel.

By separation of control panel and manipulation means it is achieved that the control panel may contain the very heavy elements needed for making a control panel, whereas the manipulation means only contain a minimum for providing the user's intention of manipulating the auxiliary device. Hereby it becomes possible for a bedfast person or a nurse to have the manipulation means in hand while the person concerned is either lying in bed or moving around in the bed. This facilitates operation of the auxiliary device, as well as it enables that the bedfast person may perform manipulation of the auxiliary device by himself.

In a further embodiment of the invention, the manipulation means communicate with the control panel by means of radio signals, voice control, wire connection, infrared or ultrasound means, or by other forms of remote control means. This is to be viewed in connection with the separate unit in which the manipulation means have been mounted. By a structure with a separate unit it is important that input from the user is transferred to the control panel which then activates the auxiliary device.

The communication itself between the unit and the control panel may e.g. be performed by means of radio signals where in the unit there is arranged a transmitter unit and in the control panel a receiver unit. As the necessary range for such a transmitter/receiver unit is relatively small, typically two meters, interference in the form of radio noise or other radio signals is very limited.

The communication may also occur with infrared light so that the manipulation means transmit a light pulse which is picked up by a receiver unit incorporated in the control panel. Correspondingly, ultrasound may be utilised as the separate unit is equipped with an ultrasound transmitter at the same time as the control panel is equipped with an ultrasound antenna.

For both of these methods, both infrared light and ultrasound, applies that if the receiver means on the control panel are placed freely, the signals from the unit will reach the control panel with very great certainty.

Besides, the manipulations means may be connected to the control panel by means of a traditional electric connection in the form of a wire.

In a further, preferred embodiment, the control panel may be provided with a microprocessor that registers the vertical movement of the roller and correspondingly activates the roller for rotation. In this connection, the microprocessor may activate a rotating motor provided in connection with the roller, whereby a sheet suspended between two parallel rollers, one at each side of the bed, is kept tight simultaneously with a synchronous movement in the two rollers may be performed, corresponding to or compensating for the vertical movement of the roller. Furthermore, the microprocessor may be used for controlling the electric voltage in the system and for registering possible failures and to give notice of failure to the user, as well as the microprocessor may control possible charging need on the rechargeable battery. However, the most important task of the microprocessor is to transform the input signals from the user to instructions to the means for relative movement, e.g. instructions to a step motor to be actuated, so that the roller is moved vertically.

In the examples of embodiments where the manipulation means are arranged in a special separate unit, the manipulation means may advantageously be supplied with energy from the control panel, as well as the telescopic cylinders are supplied with energy centrally from the control panel. When the case is that the separate unit with the manipulation means is a wireless unit, it is necessary that the wireless unit has an energy supply itself, e.g. in the form of batteries. These batteries may e.g. be coupled to a charging unit arranged in the control panel, so that when the separate unit is hung back in a holder on the control panel after use, there will automatically occur a charging of the batteries in the remote control unit.

The telescoping cylinders may furthermore be designed so that they may be locked whereby the roller is held at one level. Hereby is achieved that the roller e.g. are locked at their top position whereby, when a sheet is arranged between two rollers in parallel with the longitudinal direction of the bed but at each side of the bed, the auxiliary device will function as a kind of guard rail. This is particularly interesting in connection with persons having the tendency of being restless in bed.

The invention also concerns a bed where one or more auxiliary devices as described above has been mounted on the bed, and where between a fastening to a roller at a long side of the bed and a second roller provided at the other long side of the bed there is fastened a sheet, whereby the sheet may be moved transversely of the longitudinal direction of the bed by rotating one or both rollers.

When a bedfast person is placed upon the sheet, and the sheet is then displaced perpendicularly to the longitudinal axis of the bed due to rotation of the rollers, the lying person will thereby be pulled with the sheet until the sheet is moved upwards due to the higher level of the roller, whereby the person is forced to turn in relation to the bed. During the process, a nurse may support where needed, as well as the nurse may guide the person in the course of turning, since the nurse is not physically loaded by the turning procedure itself.

In a further, preferred embodiment, the bed is provided with an auxiliary device according to the invention at both sides of the bed. In this embodiment it becomes far easier for a nurse to turn the bedfast person to both sides as the manipulation means are arranged so that they may control the auxiliary device separately.

In a further, preferred embodiment, the bed is provided with auxiliary devices, and the manipulation means for controlling vertical movement of the auxiliary means are made with remote control means in the form of wiring, radio signals, infrared signals, ultrasound signals, or other kinds of remote control means, whereby it becomes possible for a user or a nurse to stand at a distance from the control panel, which e.g. may be secured on the bed, and simultaneously operate and control the vertical movement of the auxiliary devices simultaneously with providing for the needs in the form of support and help that that the person in the bed may have. By this embodiment, it is thus possible that less nursing staff may perform more tasks with less load on the nursing staff as a consequence.

The invention will now be described with reference to the accompanying drawings.

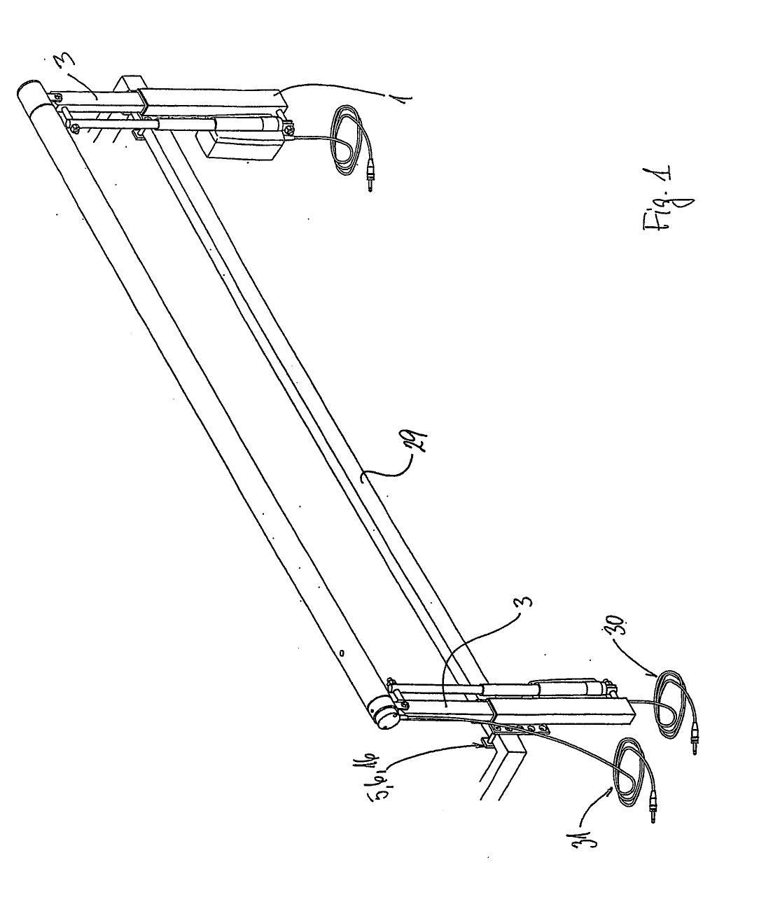

FIG. 1 shows an auxiliary device according to the invention mounted to a bed frame,

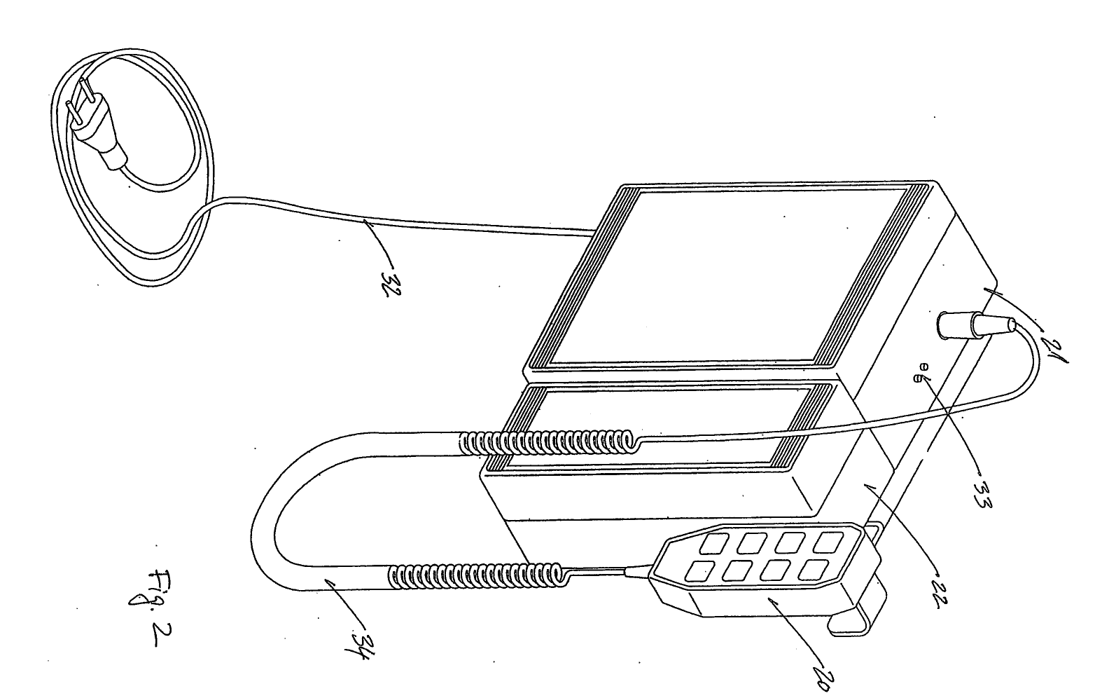

FIG. 2 shows a control panel for an auxiliary device,

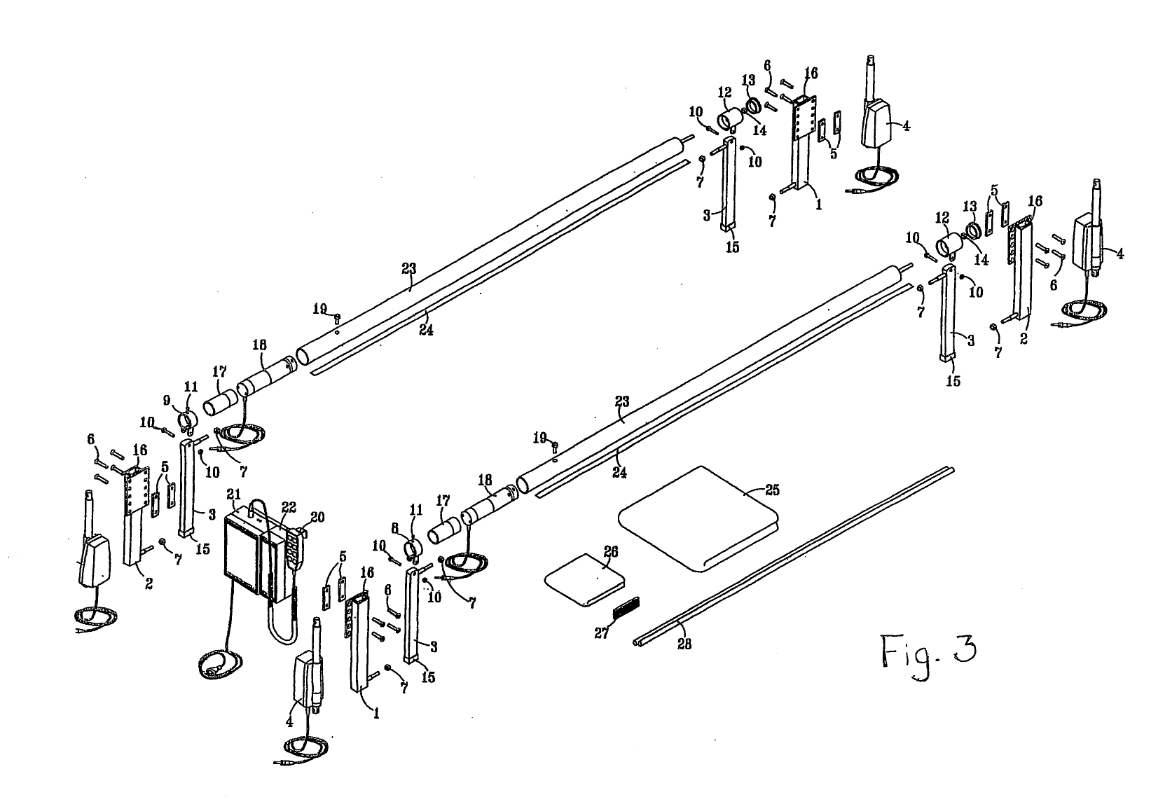

FIG. 3 shows an auxiliary device set according to the invention.

The bed frame 29 may either be an existing part of the bed and so stable that it may absorb the forces, particularly in the form of twisting, arising in connection with turning a person in the bed itself. Alternatively, a special frame may be mounted around the bed, and which is dimensioned to absorb these loads.

The device according to the invention is then mounted on the bed frame 29 by means of mounting fittings 5, 6, 16. In the embodiments where the auxiliary device is either an integrated part of a bed, or where a special frame 29 is mounted on the bed, the auxiliary bed itself may be an integrated part of the bed or this special frame, respectively.

The roller 23 around which the sheet may be fastened and rolled up, is mounted between two rotating bushings/end bearings 11, 12. In the shown example, an auxiliary motor is provided in connection with one rotatable bushing 11, where the motor may actuate the roller to turn about the longitudinal axis of the roller. The rotating bushing is fastened in a first member 3 which in this embodiment is shown as a quadrangular tube, but also oval or round tubes, or other hollow as well as solid designs of the member 3 may be used in connection with the invention.

The first member, in this case a quadrangular tube, is concentrically and vertically displacing arranged in a second member 1, so that the two members 3, 1 constitute a stable control of the roller 23. By actions transversely of the longitudinal axis of the rollers, e.g. in horizontal plane, the forces will be transmitted to the second member 1 which is fastened or integrated in the bed and bed frame 29, respectively, via the fastenings 5, 6, 16. By the vertical movement of the roller 23, the member 3 will be displaced relative to the member 1 so that the members act as a kind of telescoping joint. At each end of the roller, there is also provided a telescoping cylinder 4 provided with drive means 4. By activating the drive means 4, the cylinders 4 are actuated to vertical movement, whereby the roller 23 is moved upwards or downwards, respectively, in a vertical plane.

The impulses to this movement stem from manipulation on the control panel, whereby the signals from the control panel are transmitted via the wires 30 to the drive means 4, which may be step motors connected to the actuator 4. Transmission of instructions from manipulation means to control panel may also occur by means of wireless means.

Correspondingly, the rotation motor 18 may be brought to rotate by a pulse from the control panel to which the rotating motor 18 is connected via wire 31.

In FIG. 2 is illustrated a control panel according to the invention. The control panel mainly consists of three parts, a hand-operated unit 20 in which are arranged the manipulation means, in this case eight pcs. The control unit 21 itself in which are provided a number of inputs for connecting the hand-operated unit and a number of outlets for connecting means for vertical movement of the roller 23 and the turning motor 18 of the roller. The last element is a combined power supply, accumulator and charging unit 22, so that the control panel and thereby the entire auxiliary device becomes supplied with energy, and in case of interruption of the connection to the network 32 or power failure, a back-up power supply arranged inside the control panel in the shape of a battery with associated charging unit may take over the operation of the auxiliary device to a limited extent.

A microprocessor is provided in the control panel itself, registering the vertical position of the roller and simultaneously providing impulses to the turning motor 18 of the roller so that the sheet is rolled up or off or locked in the sequence in which the vertical movement of the roller itself is effected and as desired by the user. Besides, the microprocessor checks if any failure occurs in the system, e.g. in the form of loss of voltage or large resistance in the actuators 4. These error messages may be indicated e.g. by alarm flashes in light diodes 33, acoustic signals or flashing in the hand-operated unit.

Failure may typically occur by a bedfast patient lying partly upon the roller or in other ways having a body part stuck in the mechanism. In the shown example, the hand-operated unit 20 is connected to the control panel 21 by means of a wire 34, but in other embodiments the communication between hand-operated unit 20 and the control panel 21 may occur by wireless communication, e.g. in the form of radio signals, voice, infrared and ultrasound signals, or similar.

The microprocessor in the control panel 21 thus serves to translate the input from the hand-operated unit 20, i.e. the user's wish to manipulate the auxiliary device, into signals for the different actuators and motors in the system made. The control panel may be enlarged to comprise a number of auxiliary devices mounted on one or more beds so that a microprocessor may contribute to controlling several different beds, where the hand-operated until includes means of coding the bed desired to be operated, after which the control signals transmitted by the panel will be directed against the bed thereby selected.

By mounting on a bed according to the invention, two auxiliary devices along the long sides of the bed are arranged, either by a bed frame 29 as described above, or as an integrated part of the bed. The turning motor 18 is connected to the control panel as well as cylinder and actuator 4 are connected to the control panel. Then a sheet is laid in and the sheet is connected along both long sides to the roller, e.g. by means of a Velcro® connection. In order to distribute the pressure along the entire length of the roller, there may furthermore be laid a pressure-distributing rod in parallel with the roller. This rod serves to transmit a uniform pull to the sheet so that when the roller is brought into rotation, the rotational force is transformed into tensile force in the sheet, the tensile force being largely constant along the entire length of fastening of the sheet on the roller.

In order to facilitate the transverse movement of the sheet against the mattress, there may advantageously be arranged a slide layer, e.g. in the form of a slide sheet between the mattress and the sheet arranged on the rollers, whereby the friction between the sheet, on which the bedfast person is lying, and the upper side of the bed is reduced most possible. Hereby the load on the turning motor and on actuator and cylinder 4 is greatly reduced.

Since the sheet has been mounted with Velcro® it may readily be replaced for cleaning.

In FIG. 3 is shown an auxiliary device set according to the invention where each individual part has been illustrated before assembly. Each individual element is described in the reference list indicated below.
1. Bottom tube 2 pcs. right 5 positions. Clamped onto the bed frame.
2. Bottom tube 2 pcs. left 5 positions. Clamped onto the bed frame.
3. Stainless slide tube 4 pcs. Mounted in bottom tube, slide up and down.
4. Actuators 4 pcs. Mounted on bottom and slide tubes. Movement of motor roller up and down. Stroke 200 mm.
5. Lock plates 8 pcs. Used for clamping bottom tubes.
6. Countersunk screws 10×50 16 pcs. Used for clamping bottom tubes.
7. Self-locking nut M10 8 pcs. Used for fastening actuator.
8. Motor fitting 1 pc. Red. Mounted on slide tube, used for clamping motor.
9. Motor fitting 1 pc. Blue. Mounted on slide tube, used for clamping motor.
10. Bolt 8×40 4 pcs. Self-locking nut M8 4 pcs. Used for clamping motor fitting and end bearing.
11. Stainless pointed screw 5×6 2 pcs. Used for positioning motor in motor fitting.
12. End bearing 2 pcs. Mounted on slide tubes and used as bearing for motor roller.
13. End stopper 2 pcs. End of end bearing.
14. Self-locking nut M12 2 pcs. Mounted on thread on motor roller after mounting of end bearing.
15. Slide bushing 4 pcs. Slide bushing mounted on slide tubes, sliding inside bottom tubes.
16. Slide bushing 4 pcs. Slide bushing mounted at top of bottom tube.
17. Slide bushing 2 pcs. long, 2 pcs. short. Slide bushings mounted on motor before mounting motor fitting.
18. Motor 2 pcs. For rotating motor rollers.
19. Insex 6×16 with low head 2 pcs. Mounted through hole in motor roller down into carrier at end of motor.
20. Hand-operated unit “Vertical 4” with 8 buttons. Activation of functions.
21. Electronic control box with 6 outlets.
22. Battery back-up
23. Motor roller 2 pcs. Mounted with Velcro® band holding cotton sheet.
24. Self-adhesive Velcro®. 2 pcs. Mounted on motor rollers.
25. Cotton sheet 1 pc. Mounted on motor rollers for turning person.
26. Slide sheet 1 pc. with 10 nylon rings. Mounted over mattress in bed for reducing friction and fixing the mattress.
27. Tapes 10 pcs. For fastening slide sheet by means of nylon ring on slide sheet.
28. Nylon rods 2 pcs. Mounted in edge seam on slide sheet for distributing pull in slide sheet.
29. Fastening frame.
30. Connection to control panel.
31. Connection to control panel.
32. Connection to power network.
33. Light diodes.
34. Wire

1. Auxiliary device for turning horizontally lying persons and for mounting e.g. on a bed, the device including one or more largely vertically displacing devices that may be manipulated in vertical direction by means of a control panel, each device including a largely horizontally arranged roller which is rotatably secured at each end in a rotatable bushing, and the each rotatable bushing is fastened on first member, the first member being concentrically and displacing arranged in a second member, and means are provided by which impulses from the control panel can displace the first member relatively to the second member uniformly at both ends of the roller, which thereby may be moved vertically.

2. Device according to claim 1, wherein the means for relative displacement of the two members include a telescoping cylinder which is driven by pneumatics, hydraulics, electric step motor or the like.

3. Device according to claim 1, wherein the control panel includes one or more manipulating means providing the user input by which means for vertical movement of the roller may be controlled, and that in the control panel there is arranged a rechargeable battery with corresponding charging apparatus.

4. Device according to claim 3, wherein the manipulation means are provided in a special separate unit, which unit may communicate with input means in the control panel.

5. Device according to claim 4, wherein the manipulation means communicate with the control panel by means of radio signals, wire connection, infrared or ultrasound means, or other remote control means.

6. Device according to claim 1, wherein the control panel includes a microprocessor that registers the vertical movement of the roller and correspondingly activates the roller for activation.

7. Device according to claim 1, wherein the control panel provides the manipulation means and the telescoping cylinders with energy.

8. Device according to claim 1, wherein the telescoping cylinders may be locked whereby the roller is held at one level.

9. Bed with one or more auxiliary devices according to claim 1 mounted on the bed, and where between a fastening to a roller at a long side of the bed and a second roller provided at the other long side of the bed there is fastened a sheet, whereby the sheet may be moved transversely of the longitudinal direction of the bed by rotation of one or both rollers.

10. Bed according to claim 9, wherein a device is mounted along both long sides of the bed.

11. Bed according to claim 9, wherein manipulation means for controlling vertical movement of the auxiliary means include remote control means in the form of wiring, radio signals, infrared signals, ultrasound signals, or other kinds of remote control means.
